(19) United States
(12) Patent Application Publication
(10) Pub. No.: US 2024/0288004 A1
(43) Pub. Date: Aug. 29, 2024

(54) CEILING FAN AND BLADE

(71) Applicant: Hunter Fan Company, Memphis, TN (US)

(72) Inventors: Charles William Botkin, Cordova, TN (US); Bobby Neal Norwood, Oakland, TN (US)

(21) Appl. No.: 18/658,269

(22) Filed: May 8, 2024

Related U.S. Application Data
(63) Continuation of application No. 17/714,721, filed on Apr. 6, 2022.

(51) Int. Cl. F04D 29/38; F04D 25/08

(52) U.S. Cl. CPC F04D 29/384; F04D 25/088; F05D 2240/301

(57) ABSTRACT

A ceiling fan or similar air-moving device can include a motor for rotating one or more blades to drive a volume of air about a space. The blade can include a body with an upper surface, a lower surface, and a side edge. A performance feature can be included in the body between the upper surface and the side edge, or the lower surface and the side edge to improve efficiency. The performance feature can be tailored to the particular blade edge, shape, or intended rotational direction to increase efficiency.

### CROSS-REFERENCE TO RELATED APPLICATION

This application is a continuation application of U.S. patent application Ser. No. 17/714,721, filed Apr. 6, 2022, currently pending, of which is hereby incorporated herein by reference in its entirety.

### FIELD OF INVENTION

This application is directed to a ceiling fan for moving a volume of air about a space, and more specifically, to a blade for a ceiling fan for increased efficiency.

### BACKGROUND

Ceiling fans are machines traditionally suspended from a structure for moving a volume of air about an area. The ceiling fan includes a motor, with a rotor and stator, suspended from and electrically coupled to the structure. A set of blades mount to the rotor such that the blades are rotatably driven by the rotor, and can be provided at an angled orientation to move volume of air about the area. As the cost of energy becomes increasingly important, there is a need to improve the efficiency at which the ceiling fans operate.

### BRIEF DESCRIPTION

In one aspect, A ceiling fan comprising a motor housing and a motor at least partially encased by the motor housing and included a rotor and a stator. At least one blade coupled to the rotor. The blade comprises a body having an outer surface comprising an upper surface with a first design and lower surface with a second design, different from the first design, and the body extending between a root and a tip, defining a span-wise direction, and between a first edge and a second edge, defining a chord-wise direction, with one of the first edge and second edge defining a leading edge and the other of the first edge and second edge defining a trailing edge, a first performance feature provided on the upper surface adjacent the first edge, a second performance feature provided on the lower surface adjacent the second edge, wherein the first performance feature and second performance feature are mirrored in both the horizontal direction and vertical direction thereby enabling a flipping over of the body such that the body can be oriented in a first orientation where the upper surface with the first design faces and the lower surface with the second design faces downwardly or in a second orientation where the upper surface with the first design faces downwardly and the lower surface with the second design faces upwardly, thereby enabling a selection between the first design and second design.

In another aspect, the description relates to a ceiling fan comprising a motor housing and a motor at least partially encased by the motor housing and included a rotor and a stator. At least one blade coupled to the motor. The blade comprises a body having an outer surface comprising an upper surface with a first design and lower surface with a second design, different from the first design, and the body extending between a root and a tip, defining a span-wise direction, and between a first edge and a second edge, defining a chord-wise direction, with one of the first edge and second edge defining a leading edge and the other of the first edge and second edge defining a trailing edge, a first performance feature provided on the upper surface adjacent the first edge, a second performance feature provided on the lower surface adjacent the second edge, wherein the first performance feature and second performance feature are curved performance features that are mirrored in both the horizontal direction and vertical direction thereby enabling a flipping over of the body such that the body can be oriented in a first orientation where the upper surface with the first design faces and the lower surface with the second design faces downwardly or in a second orientation where the upper surface with the first design faces downwardly and the lower surface with the second design faces upwardly, thereby enabling a selection between the first design and second design.

In yet another aspect, the description relates to a ceiling fan comprising a motor housing and a motor at least partially encased by the motor housing and included a rotor and a stator. At least one blade coupled to the rotor and comprising a body having an outer surface comprising an upper surface and lower surface, and the body extending between a root and a tip, defining a span-wise direction, and between a first edge and a second edge, defining a chord-wise direction, with one of the first edge and second edge defining a leading edge and the other of the first edge and second edge defining a trailing edge, a first performance feature provided on the upper surface adjacent the first edge, a second performance feature provided on the lower surface adjacent the second edge, wherein the first performance feature and second performance feature are identical curved performance features that are mirrored in both the horizontal direction and vertical direction thereby enabling a flipping over of the body such that the body can be oriented in a first orientation where the upper surface faces upwardly and the lower surface faces downwardly or in a second orientation where the upper surface faces downwardly and the lower surface faces upwardly.

### BRIEF DESCRIPTION OF THE DRAWINGS

In the drawings:

FIG. 1 is a schematic view of a structure with a ceiling fan suspended from a structure and including a set of blades in accordance with aspects described herein.

FIG. 2 is a top view of a blade of the set of blades of FIG. 1 having a performance feature at a first edge and a second edge of the blade in accordance with aspects described herein.

FIG. 3 is a section view of the blade of FIG. 2 illustrating a first profile for the first edge and a second profile for the second edge in accordance with aspects described herein.

FIG. 4 is a section view of an alternative blade having a first profile for the first edge that is different from a second profile for a second edge in accordance with aspects described herein.

FIG. 5 is a section view of another alternative blade having a first profile for the first edge that is mirrored with a second profile for a second edge in accordance with aspects described herein.

FIG. 6 is a section view of yet another alternative blade having a first profile for the first edge that is different from a second profile for a second edge in accordance with aspects described herein.

FIG. 7 shows a section view of a first edge of another alternative blade having a side edge arranged at an offset angle in accordance with aspects described herein.

FIG. 8 is a section view of another blade in accordance with aspects described herein.

FIG. 9 is a top view of the blade of FIG. 8 including performance features having a varying width in the span-wise direction in accordance with aspects described herein.

FIG. 10 is a top view of an alternative blade including performance features having varying widths in the span-wise direction in accordance with aspects described herein.

FIG. 11 is a section view of yet another blade having a first performance feature along a first side edge and a second performance feature along a second side edge in accordance with aspects described herein.

FIG. 12 is a top view of the blade of FIG. 11 showing varying chord-wise widths for the first and second performance features in accordance with aspects described herein.

### DETAILED DESCRIPTION

The disclosure is related to a ceiling fan and ceiling fan blade, which can be used, for example, in residential and commercial applications. Such applications can be indoors, outdoors, or both. While this description is primarily directed toward a residential ceiling fan, it is also applicable to any environment utilizing fans or for cooling areas utilizing air movement.

As used herein, the term “set” or a “set” of elements can be any number of elements, including only one. All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

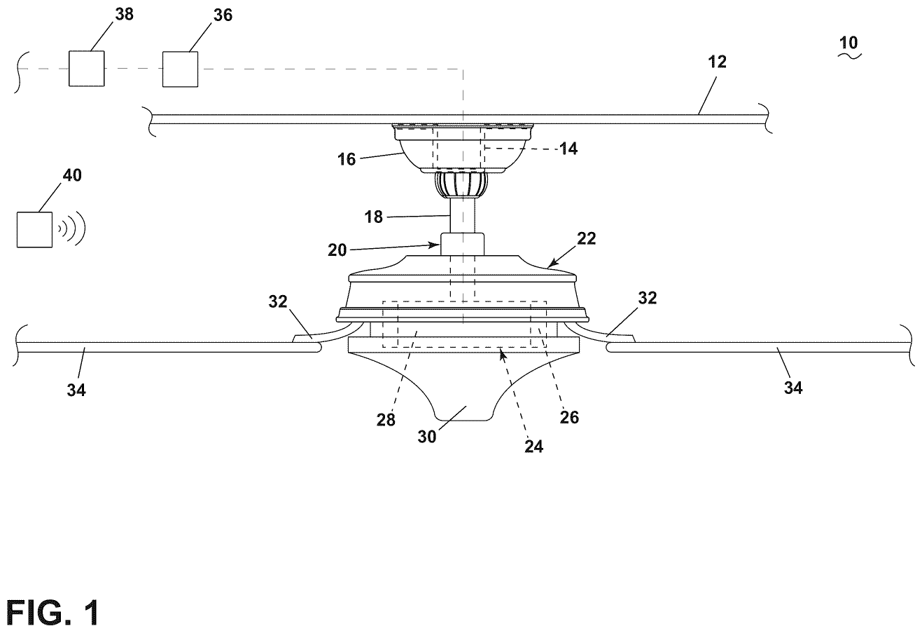

Referring now to FIG. 1, a ceiling fan 10 is suspended from a structure 12. In non-limiting examples, the ceiling fan 10 can include one or more ceiling fan components including a hanger bracket 14, canopy 16, a downrod 18, a motor adapter 20, a motor housing 22 at least partially encasing a motor 24 having a rotor 26 and a stator 28, a light kit 30, and a set of blade irons 32. In additional non-limiting examples, the ceiling fan 10 can include one or more of a controller, a wireless receiver, a ball mount, a hanger ball, a light glass, a light cage, a spindle, a finial, a switch housing, blade forks, blade tips or blade caps, or other ceiling fan components. A set of blades 34 can extend radially from the ceiling fan 10, and can be rotatable to drive a volume of fluid such as air. The blades 34 can be operably coupled to the motor 24 at the rotor 26, such as via the blade irons 32. The blades 34 can include a set of blades 34, having any number of blades, including only one blade.

The structure 12 can be a ceiling, for example, from which the ceiling fan 10 is suspended. It should be understood that the structure 12 is schematically shown and is by way of example only, and can include any suitable building, structure, home, business, or other environment wherein moving air with a ceiling fan is suitable or desirable. The structure 12 can also include an electrical supply 36 can be provided in the structure 12, and can electrically couple to the ceiling fan 10 to provide electrical power to the ceiling fan 10 and the motor 24 therein. It is also contemplated that the electrical supply be sourced from somewhere other than the structure 12, such as a battery or generator in non-limiting examples.

A controller 38 can be electrically coupled to the electrical supply 36 to control operation of the ceiling fan 10 via the electrical supply 36. Alternatively, the controller 38 can be wirelessly or communicatively coupled to the ceiling fan 10, configured to control operation of the ceiling fan 10 remotely, without a dedicated connection. Non-limiting examples of controls for the ceiling fan 10 can include fan speed, fan direction, or light operation. Furthermore, a separate wireless controller 40, alone or in addition to the wired controller 38, can be communicatively coupled to a controller or a wireless receiver in the ceiling fan 10 to control operation of the ceiling fan 10. It is further contemplated in one alternative example that the ceiling fan be operated by the wireless controller 40 alone, and is not operably coupled with the wired controller 38.

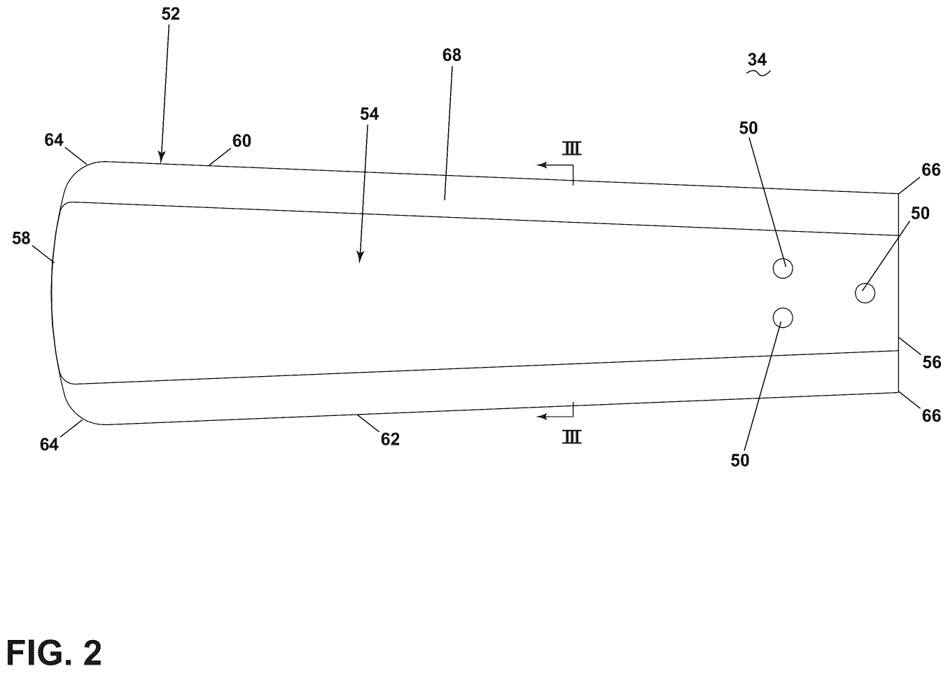

In FIG. 2, the blade 34 includes three fastener apertures 50 for directly or indirectly fastening the blade 34 to the motor 24 for rotating the blade 34 about the fan 10 of FIG. 1, while any number of fastener apertures or blade-attachment method is contemplated. The blade 34 includes a body 52 including an outer surface 54. The blade 34 extends between a root 56 and a tip 58, defining a span-wise direction therebetween, and extends between a first edge 60 and a second edge 62 defining a chord-wise direction therebetween. The first and second edges 60, 62 can be a leading edge or a trailing edge depending on rotational direction of the blade 34, and defining a chord-wise direction extending between the first edge 60 and the second edge 62. Curved corners 64 transition between the tip 58 and the side edges 60, 62 and sharp corners 66 transition between the root 56 and the side edges 60, 62, while it should be appreciated that any corner type can be utilized. The blade 34 can widen in the chord-wise direction as it extends in the span-wise direction toward the tip 58, while any top-down shape for the blade is contemplated. Non-limiting examples of blade shapes can include squared, rectangular, trapezoidal, linear, curved, angled, rounded, converging, diverging, or combinations thereof.

Furthermore, the blade 34 can include a performance feature 68 provided along the first side edge 60, the second side edge 62, and the tip 58, while the performance feature 68 extends along the root 56 only at the first and second side edges 60, 62. It should be appreciated that the performance feature is not so limited, and can extend along any combination of the root 56, tip 58, first side edge 60, and second side edge 62, or portions thereof.

A performance feature as used herein can include a feature provided adjacent one of the first edges, or another performance feature. In non-limiting examples, the performance feature can include a chamfer, a curved surface defined by an elliptical, parabolic, hyperbolic, or logarithmic geometry, or a curved feature, such that the curvature defined by the performance feature is arranged where one or both of the upper surface and the side edge are aligned tangent to the curvature of the performance feature. Where the performance feature is adjacent to another performance feature, it is contemplated that the performance feature can be arranged as sets of performance features, where at least one performance feature is adjacent to the side edge, and another is adjacent to the upper surface.

The performance feature provides for improved aerodynamic performance for the fan blade, such that operation of the ceiling fan has increased total flow volume as compared with a blade without the performance feature, or that a reduction in energy requirements can be appreciated, while maintaining the aesthetic appearance of a traditional fan blade desirable by consumers.

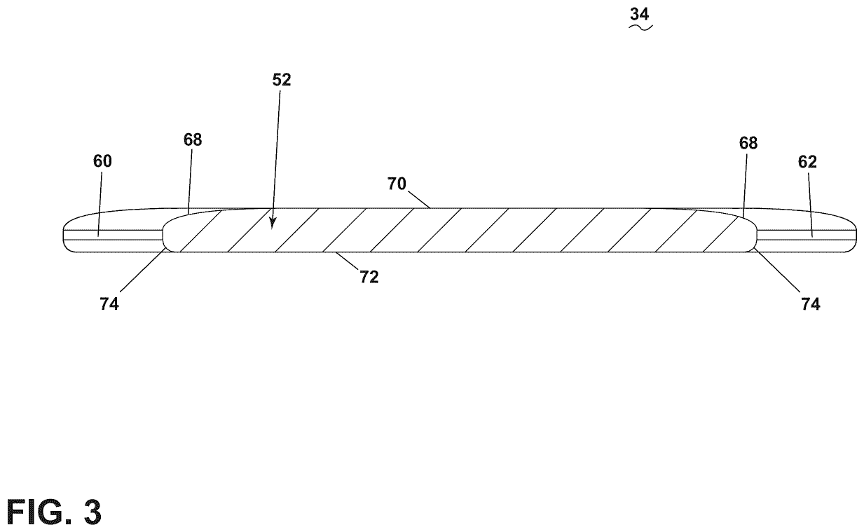

FIG. 3 shows a section view of the blade 34 taken across the section III-III of FIG. 2 along the chord-wise direction to show the profile of the blade 34. The body 52 further includes a upper surface 70 and a lower surface 72, with a rounded edge 74 transitioning between the lower surface 72 and the first and second side edges 60, 62. The first side edge 60 and the second side edge 62 can include a thickness spacing the upper surface 70 from the lower surface 72, while a nominal thickness is contemplated such that the first and second side edges 60, 62 define a line extending in the span-wise direction.

The performance feature 68 can include a curved surface, such as defining a portion of an airfoil profile in one non-limiting example. In another example, the profile for the performance feature 68, as shown, can be defined by an elliptical curvature. That is, the curvature can include a portion of an ellipse, such as including a portion extending from one end of a major axis to another end of a minor axis. Furthermore, it is contemplated that the ellipse defined by the performance feature 68 can include a major axis that is parallel to one or both of the upper surface 70 and the lower surface 72.

More specifically, performance feature 68 can be represented by equation (1) written in standard form:

$$\frac{{x}^{2}}{{a}^{2}} + \frac{{y}^{2}}{{b}^{2}} = 1 \qquad ( 1 )$$

where x represents an x-axis and y represents a y-axis in Cartesian coordinates. The x-axis can be defined in the direction extending from the upper surface 70 to the lower surface 72, and the y-axis can be defined in the chord-wise direction. Furthermore, a represents a length for the ellipse respective of the x-axis, and b represents a length for the ellipse respective of the y-axis. It should also be appreciated that where a=b, the ellipse can be a circle, defining no major or minor axis, as the diameters for a circle are equal. Additionally, all other ellipses can be non-circular, where a does not equal b, defining major and minor axes as the greatest and least diameters, respectively. Thus, it is contemplated that the performance feature 68 can define an elliptical shape, a non-circular elliptical shape, a parabolic shape, or a hyperbolic shape.

In another, the performance feature 68 can be parabolic, an equation representing at least a portion of the curvature of the performance feature 68 can be represented in standard form as:

$${( x - h )}^{2} = 4 p ( y - k ) \qquad ( 4 )$$

where the focus can be defined as (h, k+p) and the directrix is defined as y=k−p·x can represent the x-axis and y can represent the y-axis.

In another examples, where performance feature 68 is hyperbolic, an equation representing at least a portion of the curvature of the performance feature 68 can be represented in standard form as:

$$\frac{{( x - h )}^{2}}{{a}^{2}} - \frac{{( y - k )}^{2}}{{b}^{2}} = 1 \qquad ( 5 )$$

or

$$\frac{{( y - k )}^{2}}{{a}^{2}} - \frac{{( x - h )}^{2}}{{b}^{2}} = 1 \qquad ( 6 )$$

where equation (5) is based upon a horizontal transverse axis and equation (6) is based on a vertical transverse axis, which ultimately depends on the local coordinate system defining performance feature 68. (h, k) can be used to define a center for the hyperbola, while x can represent the x-axis and y can represent the y-axis.

In yet another example, it is contemplated that the performance feature 68 can be formed as a planar chamfer, extending between the first side edge 60 and the upper surface 70. In yet another example, the performance feature 68 can be formed on both the upper and the lower of the blade, as well as, on both the first and second side edges 60, 62. That is, a performance feature can be provided between a side edge and either or both of the upper and lower surfaces of the blade. Further still, it is contemplated that the use of multiple performance features can be utilized complementary to one another, or can differ from one another. For example, performance features can be common among the first and second side edges 60, 62. In another example, the performance features can differ among the first and second side edges 60, 62 depending on the intended direction of rotation of the blade, such that a leading edge can differ from a trailing edge, as well as relative to the upper or lower surfaces 70, 72. Further still, there may be multiple performance features 68 provided between the first side edge 60 and the upper surface 70, while only one performance feature 68 is illustrated.

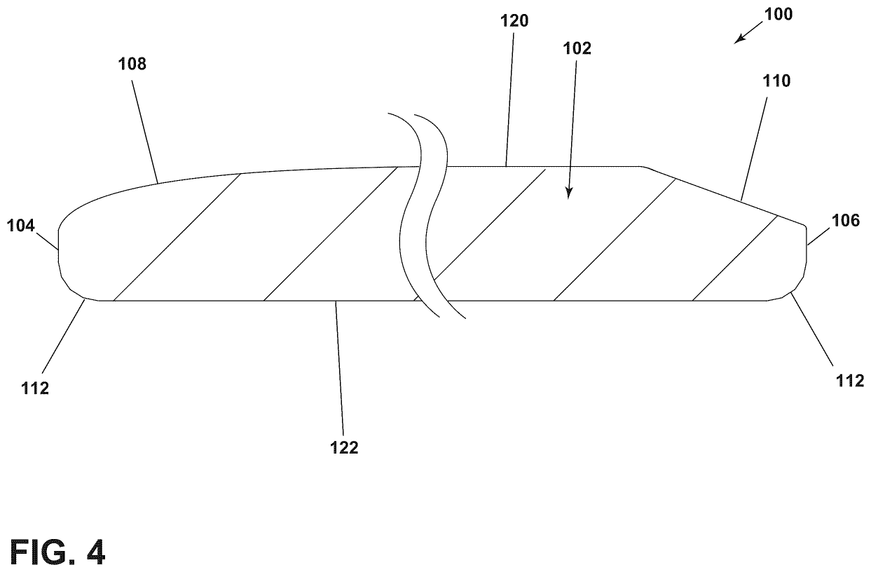

Turning to FIG. 4, a variation of the cross section shown in FIG. 3 is illustrated in a blade 100 that includes a body 102 having a first edge 104 and a second edge 106. The body 102 further includes an arrangement of a first performance feature 108 and a second performance feature 110, adjacent to the first edge 104 and the second edge 106, respectively. The first performance feature 108 can be a curved performance feature, and the second performance feature 110 can be a planar chamfer. Each performance feature 108, 110 can include a rounded transition 112 between the performance feature 108, 110 and the adjacent side edges 104, 106. Additionally, the blade 100 can include a flat planar upper surface 120 and a flat planar lower surface 122. Additional rounded transitions 112 can be provided between the side edges 104, 106 and the lower surface 122.

It should be appreciated that the first performance feature 108 is different from the second performance feature 110, such that a leading edge including the first edge 104 and the first performance feature 108 is different from a trailing edge including the second edge 106 and the second performance feature 110, while the particular leading or trailing edges can be defined by the rotational direction of the blade 100. Stated another way, a cross-sectional profile for the blade 100 at the first edge 104 and first performance feature 108, defined in the chord-wise direction, can be different that a cross-sectional profile for the blade 100 at the second edge 105 and the second performance feature 110. It should be appreciated that a ceiling fan blade can include differing geometries for a performance feature along the leading edge and a performance feature along the trailing edge, which can provide for improving efficiency when operating in different directions. For example, a curved performance feature, such as the first performance feature 108, can provide for improved efficiency when operating in a first rotational direction, while the second performance feature 110 can provide for improved efficiency when operating in a second rotational direction, opposite of the first rotational direction. In one non-limiting example the first rotational direction can move the first edge 104 into the airflow, while the second rotational direction can move the second edge 106 into the airflow. Such changes in rotational direction are typical for ceiling fans, such as accounting for operation differences between seasonal temperatures. In alternate, non-limiting examples, a performance feature can differ among one or more of along the tip, the root, the first side edge, and the second side edge.

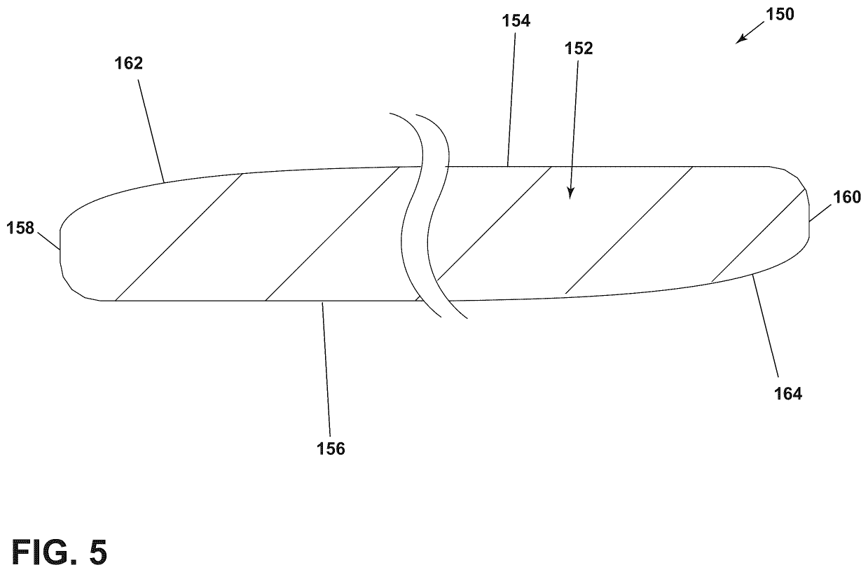

FIG. 5 shows the cross section of another exemplary blade 150 including a body 152 with an upper surface 154, a lower surface 156, a first side edge 158, and a second side edge 160. A first performance feature 162 can be provided in the upper surface 154, adjacent the first side edge 158, and a second performance feature 164 can be provided in the lower surface, adjacent the second side edge 160. Both the first and second performance features 162, 164 can be curved performance features, and can be similar or identical to one another. In this way, the first and second performance features 162, 164 can be the same, but merely mirrored in both the horizontal and vertical directions, so that one is adjacent to the first side edge 158 and on the upper surface 154, and the other is adjacent to the second side edge 160 and on the lower surface 156. It should be appreciated, however, that there may be differences between the two performance features 162, 164, such as different elliptical formulae defining each, while still remaining as curved performance features. Furthermore, it should be appreciated that the performance features need not be the same as those shown, and can include any performance feature as described herein.

The mirrored performance features 162, 164 provide for realising a performance increase resultant of the performance feature while operating in either rotational direction. Furthermore, such a blade can provide for reversibility of the blade rotational direction, such that the blade can be utilized with the upper surface 154 oriented on upper of the lower surface 156, or opposite where the blade is flipped over, with the upper surface 154 oriented on the bottom or below the lower surface 156, which could permit the use of multiple designs for a fan blade, which can provide for increased options for fan blades for a user.

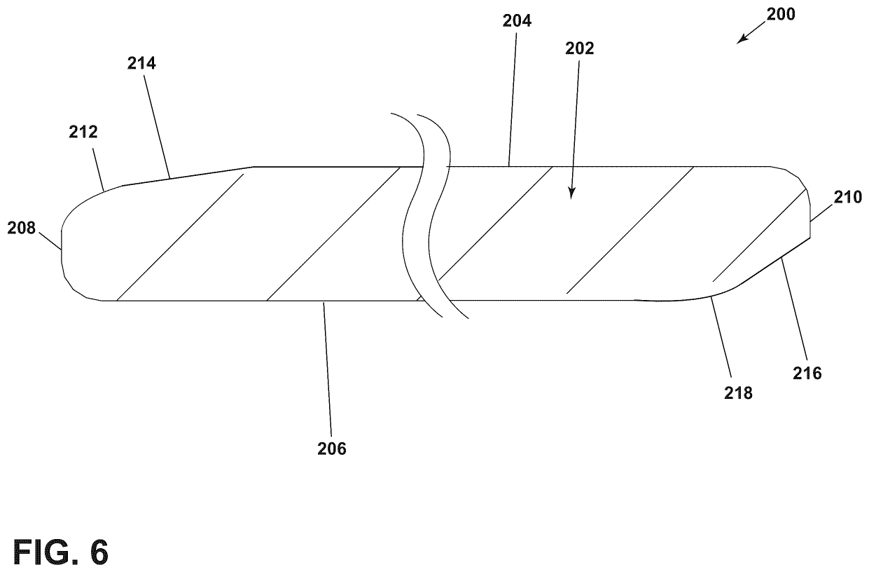

FIG. 6 shows another exemplary cross section of a blade 200 including a body 202 with an upper surface 204, a lower surface 206, a first side edge 208, and a second side edge 210. The blade 200 includes a first performance feature 212, a second performance feature 214, a third performance feature 216, and a fourth performance feature 218. The first performance feature 212 can be a curved performance feature, extending between the second performance feature 214 and the first side edge 208, and the second performance feature 214 can be a chamfer or planar performance feature, extending between the first performance feature 212 and the upper surface 204. The third performance feature 216 can be a chamfer or planar performance feature, extending between the second side edge 210 and the fourth performance feature 218, and the fourth performance feature 218 extends between the lower surface 206 and the third performance feature 216. In this way, it should be appreciated that there can be two performance features adjacent to a side edge, 210, provided on the upper and lower surfaces 204, 206, and that those two performance features can be the same, or different, or mirrored for the upper and lower surfaces 204, 206.

Additionally, it should be further appreciated that a first side, including the first side edge 208, the first performance feature 212, and the second performance feature 214, can be different than a second side, including the second side edge 210, the third performance feature 216, and the fourth performance feature 218. In this way, it should be understood that the first side of the blade 200 can be different than the second side of the blade 200, which can permit improved blade efficiencies, particularly in ceiling fans or systems where the rotational direction is reversible.

It should be further appreciated that the differences between the first and second sides of the blade 200 can be dissimilar or different, such as including a different number of performance features, different types of performance features, or where one side includes a performance feature, while the other does not, in non-limiting examples. In this way, one can tailor the particular blade to the particular implementation, which can increase operational efficiencies for the fan blade, and can be based upon the particular rotational direction.

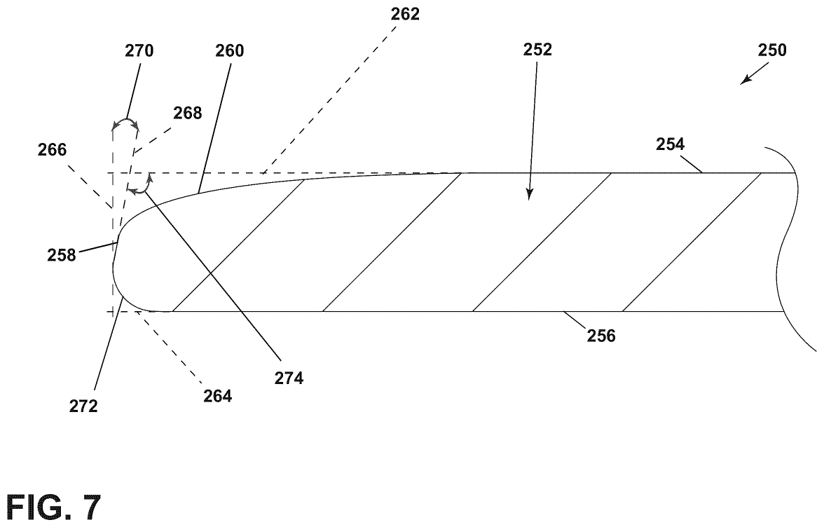

Referring now to FIG. 7, a cross section view of a blade 250 for a ceiling fan includes a body 252 with an upper surface 254, a lower surface 256, a first side edge 258, and second side edge (not shown) opposite of the first side edge 258. A performance feature 260 is provided in the body 252, extending between the upper surface 254 and the first side edge 258. A first virtual plane 262 extends from and parallel to the upper surface 254, and a second virtual plane 264 extends from and parallel to the lower surface 256. A transverse plane 266 is defined perpendicular to the first and second virtual planes 262, 264. Alternatively, it is contemplated that the first and second virtual planes 262, 264 are defined parallel to a floor below the ceiling fan, or a ceiling or other structure from which the ceiling fan is suspended. A rounded corner 272 can be provided between the first side edge 258 and the lower surface 256, while it should be understood that the rounded corner 272 can be utilized adjacent to a side edge opposite of the performance feature 260.

The first side edge 258 includes a planar surface that can further define a virtual edge plane 268. The virtual edge plane 268 can be arranged at an angle 270 relative to the transverse plane 266. The angle 270 can be within the range of −89 to 89 degrees, and further contemplated that the range can include only non-zero angles. A zero angle can be arranged perpendicular to both of the first and second virtual plane 262, 264, or parallel to the transverse plane 266, while a negative angle can define an orientation of the first side edge 258 toward the lower surface 256, while a positive angle orients the first side edge 258 toward the upper surface 254. In one non-limiting example the angle 270 can be a positive angle between about 0.5 degrees and 89 degrees. In additional non-limiting examples, the angle 270 can be between 5 and 30 degrees, or between 1 degree and 45 degrees. In an alternative example, a second angle 274 can be defined between the virtual edge plane 268, or the first side edge 258, and the first virtual plane 262, where the second angle 274 can be between 179-degrees and 91-degrees. In another example, the second angle 274 can be defined between the second virtual plane 264 and the virtual edge plane 268, where the first side edge 258 is oriented toward the lower surface 256.

Furthermore, while the performance feature 260 is shown as a curved performance feature, it should be appreciated that the performance feature 260 can be any performance feature discussed herein, such as a chamfer, for example. Similarly, it should be appreciated that the performance feature 260 need not be provided in the upper surface 254, but can be provided in the lower surface 256, or can be provided at the second side edge opposite of the first side edge 258, or both. Where multiple performance features are utilized, the performance features can be similar or different.

With the side edge 258, 260 that is arranged at the angle 270, 274, utilized with the performance feature 260, an increase in efficiency can be appreciated, as compared to a side edge that is merely a line between the upper and lower of a blade, or one that is vertical or perpendicular to the upper or lower surfaces. Additionally, such an angle can provide for performance increases for blades operational in two directions, as it can be tailored to the particular rotational direction, as well as the particular performance feature.

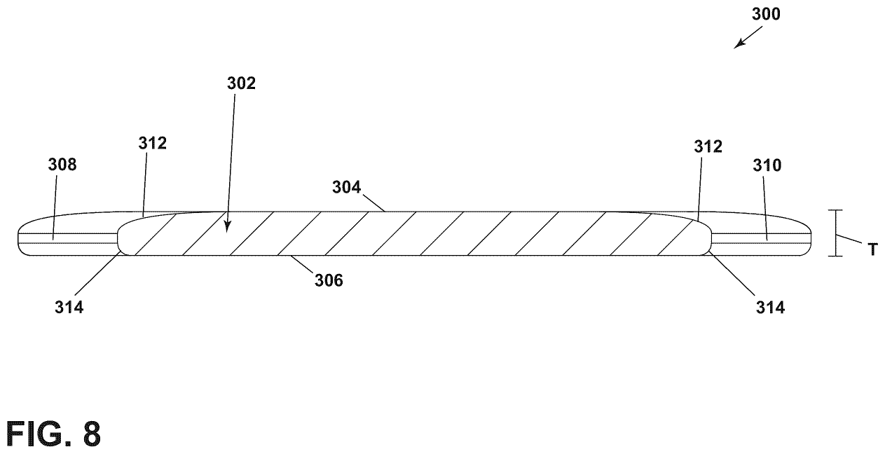

Referring to FIG. 8, another cross section of a ceiling fan blade 300 including a body 302 with an upper surface 304 and a lower surface 306, and including a first edge 308 and a second edge 310. A performance feature 312 is provided in the body 302 between the first edge 308 and the upper surface 304. A rounded corner 314 is provided between the first edge 308 and the lower surface 306. The rounded corner 314 can be formed into the body 302, and need not merely be a sharp corner that has been sanded or grinded. In one example, the rounded corner 314 can be a circular shape, such that the rounded corner 314 embodies a portion of a circle. Additionally, corner 314 could be a chamfer or other performance feature. In another example, the corner 314 could occupy between 1-30% of the total blade height at the edge 308, being defined in a direction orthogonal to the upper or lower surfaces 304, 306 T. Other examples could include between 2-30% of the total blade height, or defining a radius of curvature that is between 1-30% of the total blade height. In another example, a radius defined by a circle defining the rounded corner 314 can be greater than or equal to half of a blade thickness T, or such a radius is defined as greater than or equal to 0.5T.

The rounded corner 314, in addition to the performance feature 312 on the opposite side of the first edge 308, provides for increased operational efficiency, as compared to a blade without either or both of the rounded corner 314 and the performance feature 312. Furthermore, the rounded corner 314 permits performance increases for the blade, while retaining the aesthetic appeal to a user with a flat lower surface 306, and only the rounded corner 314 transitioning to the first edge 308.

Furthermore, it should be appreciated that the rounded corner 314 need not transition from the lower surface 306 to the first edge 308 or the second edge 310, but can be formed in the upper surface 304, and transition to the first edge 308. In such an example, the performance feature 312 could be provided at the lower surface 306, as opposed to the upper surface 304 as shown. In yet another example, the rounded corner 314 need not be a rounded corner, but could be a planar chamfer.

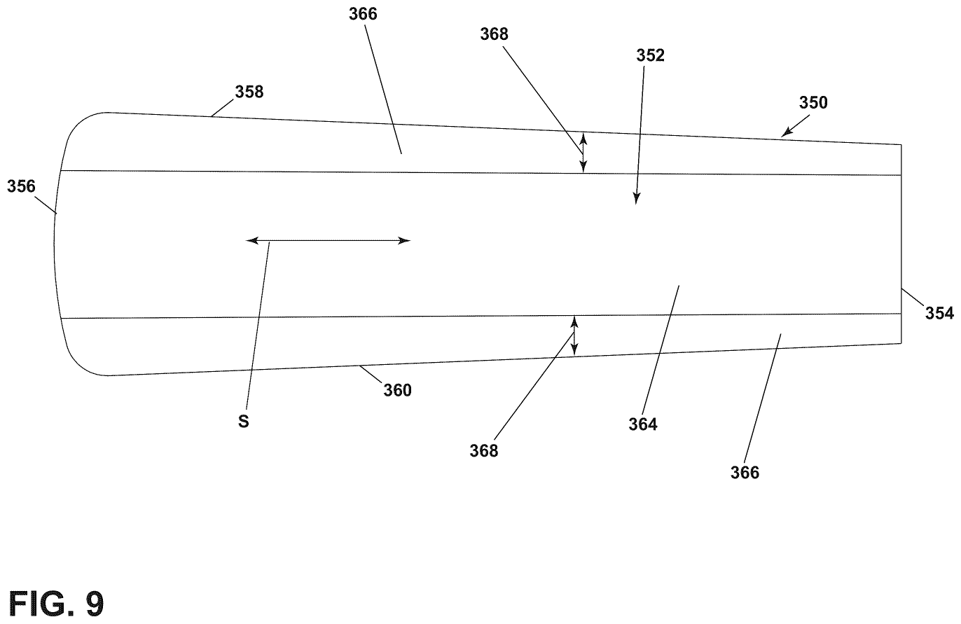

FIG. 9 includes another blade 350 including a body 352 extending between a root 354 and a tip 356 defining a span-wise direction therebetween, and extending between a first side 358 and a second side 360 defining a chord-wise direction therebetween. The body 352 includes an upper surface 364, which can be planar. A performance feature 366 is provided between the upper surface 364 and the first side 358, as well as between the upper surface 364 and the second side 360. The performance features 366 can extend between the root 354 and the tip 356, while only a partial extension is contemplated. The performance feature 366 can be any performance feature as described herein, such as a curved performance feature or a chamfer, in non-limiting examples.

The performance features 366 can include a width 368 defined in the chord-wise direction. The width 368 can vary, extending in the span-wise direction S. As shown, the width 368 increases extending in the span-wise direction S extending toward the tip 356. For example, the width 368 can vary complementary to a variation in total chord-wise width of the blade 350, such that the width 368 increases in the span-wise direction complementary or equal to a rate at which the blade width increases in the span-wise direction. In yet another example, such a variation in the width 368 could account for a variation in the total chord-wise width of the blade 3560, while the chord-wise width defined for the body 352 between the upper surface 364 and a planar lower surface maintains a constant chord-wise width. In alternative examples, the rate at which the width for each section varies in the chord-wise direction is different for each section of the blade 350. In yet another example, such a variation in the width 368 could account for a reduction or increase in chord-wise width for the flat portion of the body 352 along the upper surface 364 and the lower surface. In such an example, the rate of reduction or increase for the chord-wise width for the performance features 366 among the leading edge and the trailing edge need not be similar, but can be the same or the opposite or inverse of one another. In still another example, the chord-wise width for the each of the performance features 366 can be between 5-40% of the total chord-wise width, and can be within that range when the chord-wise width varies in the span-wise direction or between multiple performance features 366.

In alternate examples, it is contemplated that the width for the performance feature, as it extends in the span-wise direction, can vary in any way, such as continuously, discretely, or combinations thereof. For example, the width for performance feature can be related to the blade, such as occupying a portion of the body 352 defined in the chord-wise direction, such as occupying 40% of the chord-wise width of the blade as the blade width varies along the span-wise direction.

It is further contemplated that the performance feature 366 adjacent the first side 358 can be different than that of a second performance feature 366 adjacent the second side 360. Such a difference can be related or complementary to rotational direction, such that the difference can be defined relative to an intended difference in rotational direction.

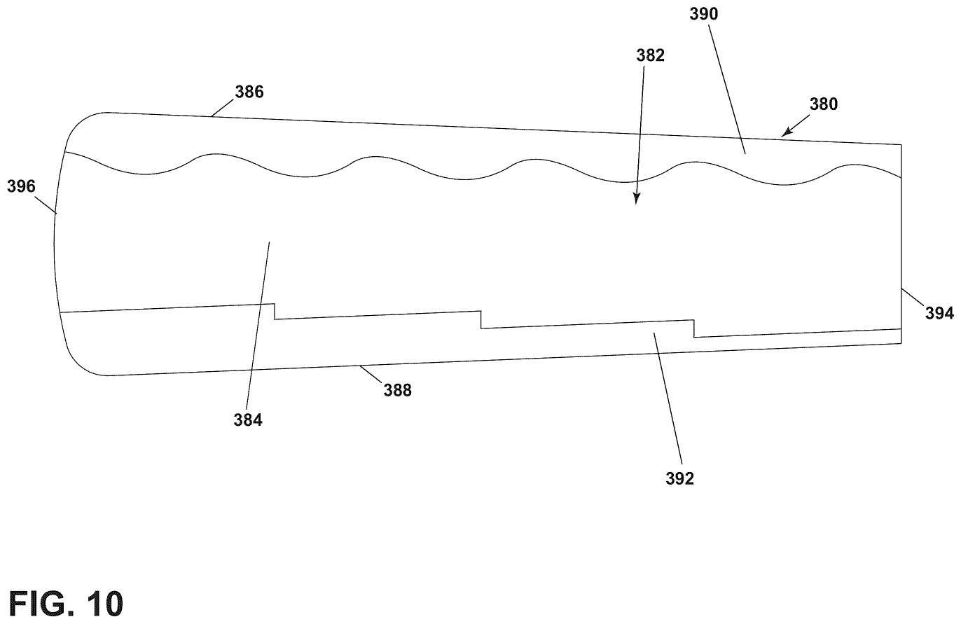

FIG. 10 shows an exemplary blade 380 that includes a performance feature with a varying width. The blade 380 includes a body 382 with an upper surface 384, and extending between a first edge 386 and a second edge 388, defining a chord-wise direction therebetween. A first performance feature 390 is provided along the first edge 386 and a second performance feature 392 is provided along the second edge 388. The performance features 390, 392 can extend fully between a root 394 and a tip 396, defining a span-wise direction therebetween, while it is contemplated that the performance feature 390, 392 extend only partially or discretely in the span-wise direction.

The first performance feature 390 includes a varying width defined in the chord-wise direction, such that the width varies in the chord-wise direction as it extends along the span-wise extent of the blade 380. The varying width can be sinusoidal, such that the width both increases and decreases extending in the span-wise direction in a curved manner. The second performance feature 392 includes a discrete varying width, such that the width varies in a step-wise manner extending in the span-wise direction. While four steps are shown, it should be appreciated that any number of discrete steps is contemplated.

It is contemplated that the varying width for a blade can include any type of variation, including but not limited to, an increasing width, a decreasing width, a constantly increasing width, a constantly decreasing width, an increasing width that increases at a non-constant rate, a decreasing width that decreases at a non-constant rate, a discretely varying width, a sinusoidal or increasing and decreasing width, a width that varies relative to span-wise position of the blade, a width that varies relative to a thickness of the blade, a width a random or non-patterned change, a width that is linear, non-linear, curved, unique, or geometric, or any combination thereof. Further, in a blade that includes two performance features, the performance features can be complementary to one another, similar, identical, or dissimilar. For example, the width for the performance features can vary in the same way or same manner at the same span-wise position. In another example, the performance features can vary complementary to one another, but where a first performance feature increases at a constant rate and a second performance feature decreases at the same rate. In this way, it should be appreciated that any varying chord-wise width for a performance feature is contemplated, and any complement or lack thereof with a second performance feature is similarly contemplated. The varying widths for the performance features can be utilized to tailor the performance feature to span-wise position of the blade, which can increase overall blade performance with local efficiency increases realised by the local or discrete performance feature.

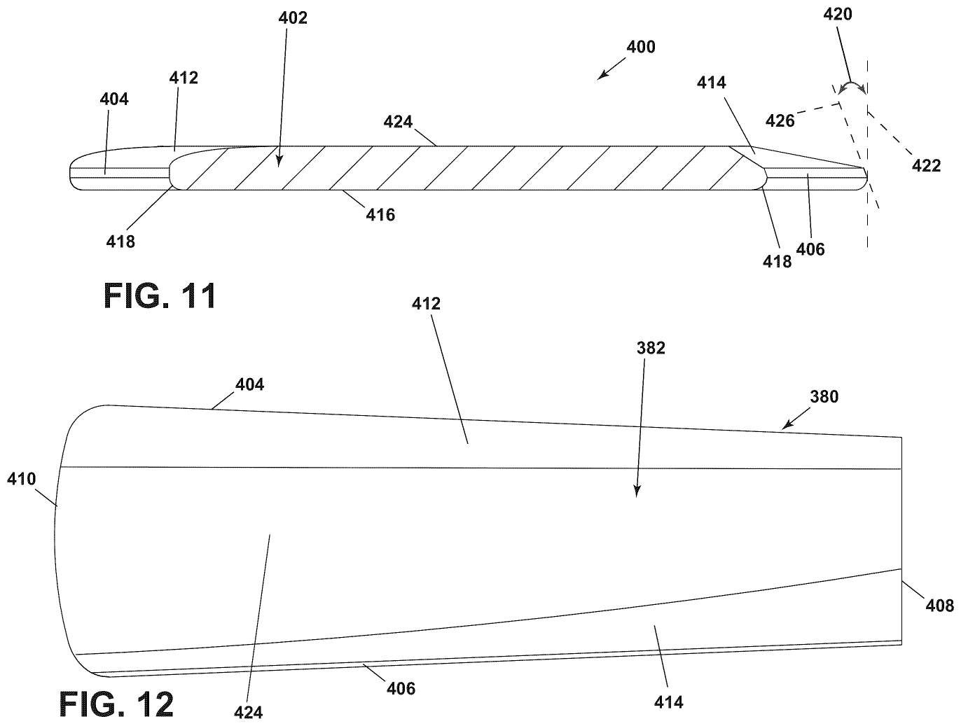

FIGS. 11-12 illustrate various performance features, or other features incorporated in addition to the performance features. It should be appreciated that the features shown can be combined or interchanged with any of the other features included in FIGS. 11-12, as well as further combined or interchanged with any of concepts discussed in FIGS. 1-7. In this way, it should be understood that one or more of the aspects described herein can be combined or intermixed with one or more other aspects described herein. FIGS. 11-12 provide one non-limiting example thereof.

FIG. 11 shows a first non-limiting example of a blade 400. The blade 400 includes a body 402 extending between a first side edge 404 and a second side edge 406, and a root 408 and a tip 410. The blade 400 includes a first performance feature 412 and a second performance feature 414 adjacent to an upper surface 424 and spaced from a lower surface 416.

The first performance feature 412 and the second performance feature 414 are different, with the first performance feature 412 formed as an elliptical performance feature and the second performance feature 414 formed as a chamfer performance feature. In this way, the performance feature varies among the first side edge 404 and the second side edge 406, similar to that provided in FIGS. 4-6.

The first side edge 404 is planar, spacing the first performance feature 412 from the lower surface 416. The lower surface 416 includes a rounded transition 418, transitioning between the first side edge 404 and the lower surface 416. In this way, the blade 400 includes a rounded corner similar to that of FIG. 8.

The second side edge 406 is planar, spacing the second performance feature 414 from the lower surface 416. The second side edge 406 can be arranged at an offset angle 420. The offset angle 420 can be defined between a plane 426 defined by the second performance feature 414 and a vertical axis 422, arranged perpendicular to a plane defined parallel to the upper surface 424.

Turning to FIG. 12, the first performance feature 412 includes a varying chord-wise width, increasing at a constant rate and extending in a span-wise direction from the root 408 toward the tip 410. The second performance 414 also includes a varying width, decreasing at a non-constant rate and extending in the span-wise direction from the root 408 to the tip 410. In this way, the performance feature 412, 414 varies among the first side edge 404 and the second side edge 406, similar to that provided in FIGS. 9-10.

It should be appreciated that FIGS. 11-12 show but one example of combining features from the concepts described herein, and that there are numerous combinations that can be made with the concepts included herein as would be readily appreciated by one having ordinary skill in the art. Any combination of one or more of the concepts described herein is contemplated.

Similarly, it is contemplated that any performance feature or concept described herein can be mirrored among the first edge and the second edge, such as mirrored about one or both of a horizontal axis or a vertical axis. In this way, the first edge and the second edge can be similar or complementary to one another, but being mirrored relative to the vertical or horizontal.

The blades and portions thereof, and concepts relating thereto, as described herein, provide for increased total flow volume for a ceiling fan, resulting in increased operational efficiency, while maintaining the aesthetic appearance that consumers desire. Furthermore, the transition portions, the performance features, side edges, curved upper or lower surfaces, or other details described herein provide for increased downward and/or upward force on air which increases the total volume of airflow, as well as fans that operate in two directions, while the flat upper and lower surfaces of the blade match traditional fan blade styles, providing a pleasing or appealing user aesthetic.

To the extent not already described, the different features and structures of the various features can be used in combination as desired. That one feature is not illustrated in all of the aspects of the disclosure is not meant to be construed that it cannot be, but is done for brevity of description. Thus, the various features of the different aspects described herein can be mixed and matched as desired to form new features or aspects thereof, whether or not the new aspects or features are expressly described. All combinations or permutations of features described herein are covered by this disclosure.

This written description uses examples to detail the aspects described herein, including the best mode, and to enable any person skilled in the art to practice the aspects described herein, including making and using any devices or systems and performing any incorporated methods. The patentable scope of the aspects described herein are defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A ceiling fan comprising:
a motor housing;
a motor at least partially encased by the motor housing and included a rotor and a stator;
at least one blade coupled to the rotor and comprising:
a body having an outer surface comprising an upper surface with a first design and lower surface with a second design, different from the first design, and the body extending between a root and a tip, defining a span-wise direction, and between a first edge and a second edge, defining a chord-wise direction, with one of the first edge and second edge defining a leading edge and the other of the first edge and second edge defining a trailing edge,
a first performance feature provided on the upper surface adjacent the first edge,
a second performance feature provided on the lower surface adjacent the second edge,
wherein the first performance feature and second performance feature are mirrored in both a horizontal direction and a vertical direction thereby enabling a flipping over of the body such that the body can be oriented in a first orientation where the upper surface with the first design faces and the lower surface with the second design faces downwardly or in a second orientation where the upper surface with the first design faces downwardly and the lower surface with the second design faces upwardly, thereby enabling a selection between the first design and second design.

2. The ceiling fan of claim 1 wherein the first performance feature extends between the upper surface and the first edge, and the second performance feature extends between the lower surface and the second edge.

3. The ceiling fan of claim 2 wherein at least one of the upper surface and lower surface is flat.

4. The ceiling fan of claim 3 wherein both the upper surface and lower surface are flat.

5. The ceiling fan of claim 4 wherein the first performance feature extends from the upper surface to the lower surface and the second performance feature extends from the lower surface to the upper surface.

6. The ceiling fan of claim 4 wherein the first edge defines a first flat and the second edge defines a second flat.

7. The ceiling fan of claim 6 wherein the first edge further defines a first radius extending between the first flat and the lower surface, and the second edge further defines a second radius extending between the second flat and the upper surface.

8. The ceiling fan of claim 7 wherein the first performance feature and the second performance feature are curved performance features.

9. The ceiling fan of claim 7 wherein the first performance feature and the second performance feature are a planar performance feature.

10. The ceiling fan of claim 1 wherein the first performance feature and the second performance feature are curved performance features.

11. The ceiling fan of claim 10 wherein the curved performance features define a curved surface having an elliptical curvature.

12. The ceiling fan of claim 10 wherein the curved performance features define a curved surface having a hyperbolic curvature.

13. The ceiling fan of claim 10 wherein the curved performance features define a curved surface having a parabolic curvature.

14. The ceiling fan of claim 10 wherein the curved performance features define a curved surface having a logarithmic curvature.

15. The ceiling fan of claim 1 wherein the first performance feature and the second performance feature are a planar performance feature.

16. The ceiling fan of claim 15 wherein the planar performance feature is a chamfer.

17. The ceiling fan of claim 1 further comprising a rounded corner between at least one of the first edge and the upper surface or between the second edge and the lower surface.

18. The ceiling fan of claim 1 further comprising a rounded corner between at least one of the first edge and the lower surface or between the second edge and the upper surface.

19. A ceiling fan comprising:
a motor housing;
a motor at least partially encased by the motor housing and included a rotor and a stator;
at least one blade coupled to the rotor and comprising:
a body having an outer surface comprising an upper surface with a first design and lower surface with a second design, different from the first design, and the body extending between a root and a tip, defining a span-wise direction, and between a first edge and a second edge, defining a chord-wise direction, with one of the first edge and second edge defining a leading edge and the other of the first edge and second edge defining a trailing edge,
a first performance feature provided on the upper surface adjacent the first edge,
a second performance feature provided on the lower surface adjacent the second edge,
wherein the first performance feature and second performance feature are curved performance features that are mirrored in both a horizontal direction and a vertical direction thereby enabling a flipping over of the body such that the body can be oriented in a first orientation where the upper surface with the first design faces and the lower surface with the second design faces downwardly or in a second orientation where the upper surface with the first design faces downwardly and the lower surface with the second design faces upwardly, thereby enabling a selection between the first design and second design.

20. The ceiling fan of claim 19 wherein the first performance feature extends between the upper surface and the first edge, and the second performance feature extends between the lower surface and the second edge.

21. The ceiling fan of claim 20 wherein at least one of the upper surface and lower surface is flat.

22. The ceiling fan of claim 21 wherein both the upper surface and lower surface are flat.

23. The ceiling fan of claim 22 wherein the first performance feature extends from the upper surface to the lower surface and the second performance feature extends from the lower surface to the upper surface.

24. The ceiling fan of claim 22 wherein the first edge defines a first flat and the second edge defines a second flat.

25. The ceiling fan of claim 24 wherein the first edge further defines a first radius extending between the first flat and the lower surface, and the second edge further defines a second radius extending between the second flat and the upper surface.

26. A ceiling fan comprising:
a motor housing;
a motor at least partially encased by the motor housing and included a rotor and a stator;
at least one blade coupled to the rotor and comprising:
a body having an outer surface comprising an upper surface and lower surface, and the body extending between a root and a tip, defining a span-wise direction, and between a first edge and a second edge, defining a chord-wise direction, with one of the first edge and second edge defining a leading edge and the other of the first edge and second edge defining a trailing edge,
a first performance feature provided on the upper surface adjacent the first edge,
a second performance feature provided on the lower surface adjacent the second edge,
wherein the first performance feature and second performance feature are identical curved performance features that are mirrored in both a horizontal direction and a vertical direction thereby enabling a flipping over of the body such that the body can be oriented in a first orientation where the upper surface faces upwardly and the lower surface faces downwardly or in a second orientation where the upper surface faces downwardly and the lower surface faces upwardly.

27. The ceiling fan of claim 26 wherein the first performance feature extends between the upper surface and the first edge, and the second performance feature extends between the lower surface and the second edge.

28. The ceiling fan of claim 27 wherein both the upper surface and lower surface are flat.

29. The ceiling fan of claim 28 wherein the first performance feature extends from the upper surface to the lower surface and the second performance feature extends from the lower surface to the upper surface.

30. The ceiling fan of claim 29 wherein the first edge defines a first flat and the second edge defines a second flat, and the first edge further defines a first radius extending between the first flat and the lower surface, and the second edge further defines a second radius extending between the second flat and the upper surface.
